(19) United States
(12) Patent Application Publication
(10) Pub. No.: US 2023/0113174 A1
(43) Pub. Date: Apr. 13, 2023

(54) SOLID-STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi, Aichi-ken (JP)

(21) Appl. No.: 17/943,859

(22) Filed: Sep. 13, 2022

(30) Foreign Application Priority Data
Sep. 24, 2021 (JP) 2021155101

(51) Int. Cl. H01M 10/0562; H01M 10/0525

(52) U.S. Cl. CPC H01M 10/0562; H01M 10/0525

(57) ABSTRACT

A solid-state battery including a cathode layer, a solid electrolyte layer and an anode layer in this order. The solid electrolyte layer includes a first solid electrolyte layer and a second solid electrolyte layer. The first solid electrolyte layer is disposed adjacent to the cathode layer or the anode layer. The second solid electrolyte layer is disposed adjacent to the first solid electrolyte layer. The first solid electrolyte layer includes a solid electrolyte. The second solid electrolyte layer includes a support with pores and the solid electrolyte, and the second solid electrolyte layer is a sheet in which the solid electrolyte is fixed on a surface of and in the pores of the support.

### CROSS-REFERENCE TO RELATED APPLICATION

This application claims priority to Japanese Patent Application No. 2021-155101, filed on Sep. 24, 2021. The disclosure of the prior application is hereby incorporated by reference herein in its entirety.

### TECHNICAL FIELD

The disclosure relates to a solid-state battery.

### BACKGROUND

A solid-state battery has attracted attention since it uses, instead of a liquid electrolyte containing an organic solvent, a solid electrolyte as the electrolyte disposed between the cathode and the anode.

Patent Literature 1 discloses a solid electrolyte sheet including a nonwoven fabric and a solid electrolyte fixed on and in the nonwoven fabric.

Patent Literature 2 discloses a separator in which crystalline oxide-based inorganic solid electrolyte particles are supported in one layer on a substrate. Patent Literature 2 also discloses that the solid electrolyte particles are exposed on both surfaces of the separator; the exposure rate of the solid electrolyte particles is 10% to 100% on each surface of the separator; and the substrate is made of nonwoven fabric.

Patent Literature 1: Japanese Patent Application Laid-Open (JP-A) No. 2016-031789

Patent Literature 2: JP-A No. 2020-188026

From the viewpoint of increasing the capacity retention rate of a solid-state battery, a solid electrolyte layer including a support is used as the solid electrolyte layer of the solid-state battery.

In the solid-state battery using the solid electrolyte layer including the support, the contact resistance of the solid electrolyte layer, cathode and anode is high. Accordingly, the solid-state battery using the solid electrolyte layer including the support, is required to maintain a desired capacity retention rate and reduce battery resistance.

### SUMMARY

The present disclosure was achieved in light of the above circumstances. An object of the present disclosure is to provide a solid-state battery configured to have high capacity retention rate and low battery resistance even in the case of using a solid electrolyte layer including a support.

The solid-state battery of the present disclosure is a solid-state battery comprising a cathode layer, a solid electrolyte layer and an anode layer in this order,
wherein the solid electrolyte layer comprises a first solid electrolyte layer and a second solid electrolyte layer;
wherein the first solid electrolyte layer is disposed adjacent to the cathode layer or the anode layer;
wherein the second solid electrolyte layer is disposed adjacent to the first solid electrolyte layer;
wherein the first solid electrolyte layer comprises a solid electrolyte; and
wherein the second solid electrolyte layer comprises a support with pores and the solid electrolyte, and the second solid electrolyte layer is a sheet in which the solid electrolyte is fixed on a surface of and in the pores of the support.

The solid electrolyte layer may further comprise a third solid electrolyte layer.

The first solid electrolyte layer may be disposed adjacent to the anode layer.

The third solid electrolyte layer may be disposed adjacent to the cathode layer.

The second solid electrolyte layer may be disposed between the first solid electrolyte layer and the third solid electrolyte layer.

The third solid electrolyte layer may comprise the solid electrolyte.

The porosity of the support may be 70% or more and 90% or less.

The support may be a non-woven fabric.

The solid electrolyte may be a sulfide-based solid electrolyte.

The thickness of the second solid electrolyte layer may be 10 µm or more and 25 µm or less.

The thickness of the first solid electrolyte layer and that of the third solid electrolyte layer may be 3 µm or more and 10 µm or less.

According to the present disclosure, the solid-state battery configured to have high capacity retention rate and low battery resistance even in the case of using a solid electrolyte layer including a support, is provided.

### BRIEF DESCRIPTION OF THE DRAWING

FIG. 1 is a schematic sectional view of an example of the solid-state battery of the present disclosure.

### DETAILED DESCRIPTION

The solid-state battery of the present disclosure is a solid-state battery comprising a cathode layer, a solid electrolyte layer and an anode layer in this order,
wherein the solid electrolyte layer comprises a first solid electrolyte layer and a second solid electrolyte layer;
wherein the first solid electrolyte layer is disposed adjacent to the cathode layer or the anode layer;
wherein the second solid electrolyte layer is disposed adjacent to the first solid electrolyte layer;
wherein the first solid electrolyte layer comprises a solid electrolyte; and
wherein the second solid electrolyte layer comprises a support with pores and the solid electrolyte, and the second solid electrolyte layer is a sheet in which the solid electrolyte is fixed on a surface of and in the pores of the support.

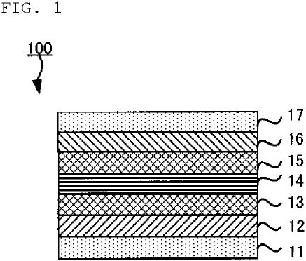

FIG. 1 is a schematic sectional view of an example of the solid-state battery of the present disclosure.

As shown in FIG. 1, a solid-state battery 100 includes an anode collector 11, an anode layer 12, a first solid electrolyte layer 13, a second solid electrolyte layer 14, a third solid electrolyte layer 15, a cathode layer 16 and a cathode collector 17 in this order.

The solid-state battery of the present disclosure includes the cathode layer, the solid electrolyte layer and the anode layer in this order.

The solid-state battery of the present disclosure may include a cathode including the cathode layer, the solid electrolyte layer, and an anode including the anode layer.

### Solid Electrolyte Layer

The solid electrolyte layer includes at least the first solid electrolyte layer and the second solid electrolyte layer. As needed, it may further include a third solid electrolyte layer.

When the solid electrolyte layer has a two-layer structure, the first solid electrolyte layer is disposed adjacent to the cathode layer or the anode layer.

When the solid electrolyte layer has a two-layer structure, the second solid electrolyte layer is disposed adjacent to the first solid electrolyte layer.

When the solid electrolyte layer has a three-layer structure, the first solid electrolyte layer is disposed adjacent to the anode layer.

When the solid electrolyte layer has a three-layer structure, the third solid electrolyte layer is disposed adjacent to the cathode layer.

When the solid electrolyte layer has a three-layer structure, the second solid electrolyte layer is disposed between the first solid electrolyte layer and the third solid electrolyte layer.

The second solid electrolyte layer includes the support with the pores and the solid electrolyte.

The second solid electrolyte layer is the sheet in which the solid electrolyte is fixed on the surface of and in the pores of the support. By disposing the solid electrolyte on the surface of and in the pores of the support, the contact area between the cathode/anode and the solid electrolyte is increased, and the battery resistance is reduced.

The support is not particularly limited, as long as it has pores. For example, the support may be a non-woven fabric. While a woven fabric, in which pores are formed by spaces between fibers, has a sharp pore size distribution, a non-woven fabric has a wide pore size distribution, and it has large pores having a large pore volume and small pores having a small pore volume. In the case of using a non-woven fabric in which a solid electrolyte is fixed on the surface and in the pores, small pores effectively suppress the detachment of the solid electrolyte and exhibit self-supporting properties and flexibility, and large pores function to form an ion path.

The material for the fibers used in the non-woven fabric is not particularly limited. It may be fibers which have no adverse effect on the solid electrolyte and which have both insulation properties and flexibility. As the material for the fiber, examples include, but are not limited to, resins such as polyester resin, polyolefin resin and polyamide resin. As the polyester resin, examples include, but are not limited to, polyethylene terephthalate (PET). As the polyolefin resin, examples include, but are not limited to, polyethylene (PE) and polypropylene (PP). As the polyamide resin, examples include, but are not limited to, nylon and aramid. As the material for the fibers, glass may be used. That is, the non-woven fabric may be a glass fiber non-woven fabric. The diameter and length of the fibers constituting the non-woven fabric are not particularly limited.

As the type of the non-woven fabric, examples include, but are not limited to, a chemical bonded nonwoven fabric, a thermal bonded nonwoven fabric, an air-laid nonwoven fabric, a spunlace nonwoven fabric, a spunbonded nonwoven fabric, a meltblown nonwoven fabric, a needle-punched nonwoven fabric, and a stitch-bonded nonwoven fabric.

The porosity of the support is not particularly limited. For example, the porosity of the support may be 50% or more, 60% or more, or 70% or more. When the porosity of the support is too small, the internal resistance of the support is likely to increase. On the other hand, the porosity of the support may be 95% or less, or it may be 90% or less, for example. When the porosity of the support is too large, there is a possibility that the support fails to function as a support. The porosity of the support is obtained by, for example, observing a section of the non-woven fabric. The size of the pores (voids) is not particularly limited.

The percentage of the total volume of the solid electrolyte with respect to the total volume of the pores in the support, may be 50 volume % or more, 70 volume % or more, or 90 volume % or more.

The thickness of the support is 1 µm or more, for example. It may be 5 µm or more, or it may be 10 µm or more. On the other hand, the thickness of the support may be 25 µm or less, for example. The thickness of the support may be the same as the thickness of the second solid electrolyte layer.

The thickness of the second solid electrolyte layer may be 10 µm or more and 25 µm or less.

Since the thickness of the second solid electrolyte layer is 10 µm or more, the solid electrolyte is contained in the surface of and the pores of the support, the solid electrolyte is distributed in the pores and penetrates to the rear of the support. Accordingly, the above-mentioned functions are ensured. Since the thickness of the second solid electrolyte layer is 25 µm or less, an increase in the impedance of the solid-state battery is suppressed, and a decrease in the discharge capacity of the solid-state battery is suppressed.

The method for producing the second solid electrolyte layer is as follows, for example: the support is stacked on a substrate; a coating solution containing the solid electrolyte (i.e., a solid electrolyte layer paste) is applied to the surface of the support; the applied coating solution is dried, thereby forming the second solid electrolyte layer. After drying the coating liquid, the support is removed from the substrate, thereby producing the second solid electrolyte layer which is a self-supporting layer. The substrate of the support is not particularly limited, as long as it is a substrate which is not soluble in the solvent used in the solid electrolyte layer paste, such as xylene. As the substrate, examples include, but are not limited to, a metal foil, a glass plate and a polyethylene terephthalate film.

The first solid electrolyte layer and the third solid electrolyte layer contain the solid electrolyte.

The thickness of the first solid electrolyte layer and that of the third solid electrolyte layer may be 3 µm or more and 10 µm or less. The thickness of the first solid electrolyte layer and that of the third solid electrolyte layer may be the same, or they may be different from each other.

For example, the first and third solid electrolyte layers may be formed by the method of press-forming a solid electrolyte material powder containing a solid electrolyte. In the case of press-forming the solid electrolyte material powder, generally, a press pressure of 1 MPa or more and 2000 or less is applied.

The pressing method is not particularly limited. As the pressing method, examples include a pressing method exemplified below in the formation of the cathode layer.

As the solid electrolyte contained in the solid electrolyte layer, a conventionally-known solid electrolyte that is applicable to solid-state batteries can be appropriately used, such as a sulfide-based solid electrolyte, an oxide-based solid electrolyte, a hydride-based solid electrolyte, a halide-based solid electrolyte and a nitride-based solid electrolyte. The sulfide-based solid electrolyte may contain sulfur (S) as the main component of an anionic element. The oxide-based solid electrolyte may contain oxygen (O) as the main component of an anionic element. The hydride-based solid electrolyte may contain hydrogen (H) as the main component of an anionic element. The halide-based solid electrolyte may contain halogen (X) as the main component of an anionic element. The nitride-based solid electrolyte may contain nitrogen (N) as the main component of an anionic element.

As the sulfide-based solid electrolyte, examples include, but are not limited to, Li₂S-P₂S₅, Li₂S-SiS₂, LiX-Li₂S-SiS₂, LiX-Li₂S-P₂S₅, LiX-Li₂O-Li₂S-P₂S₅, LiX-Li₂S-P₂O₅, LiX-Li₃PO₄-P₂S₅ and Li₃PS₄. Note that the description “Li₂S-P₂S” means a material consisting of a raw material composition including Li₂S and P₂S₅, and the same applies to other descriptions. Also, “X” of the above-described LiX indicates a halogen element. The raw material composition may contain one or two or more kinds of LiX. When two or more kinds of LiX are contained, the mixing ratio of the two or more kinds of LiX is not particularly limited.

The molar ratio of the elements in the sulfide-based solid electrolyte can be controlled by adjusting the amounts of the elements in the raw material. Also, the molar ratio and composition of the elements in the sulfide-based solid electrolyte can be measured by ICP emission spectrometry, for example.

The sulfide-based solid electrolyte may be a sulfide glass, a crystalline sulfide glass (glass ceramic) or a crystalline material obtained by carrying out a solid-phase reaction treatment on the raw material composition.

The crystal state of the sulfide-based solid electrolyte can be confirmed, for example, by carrying out powder X-ray diffraction measurement using CuKα rays on the sulfide-based solid electrolyte.

The sulfide glass can be obtained by carrying out an amorphous treatment on the raw material composition such as a mixture of Li₂S and P₂S₅. As the amorphous treatment, examples include, but are not limited to, mechanical milling.

The glass ceramic can be obtained, for example, by heat-treating a sulfide glass.

The heat treatment temperature may be a temperature higher than the crystallization temperature (Tc) observed by thermal analysis measurement of the sulfide glass, and it is generally 195° C. or more. On the other hand, the upper limit of the heat treatment temperature is not particularly limited.

The crystallization temperature (Tc) of the sulfide glass can be measured by differential thermal analysis (DTA).

The heat treatment time is not particularly limited, as long as the desired crystallinity of the glass ceramic is obtained. For example, it is within a range of from one minute to 24 hours, and it may be within a range of from one minute to 10 hours.

The heat treatment method is not particularly limited. As the heat treatment method, examples include, but are not limited to, a heat treatment method using a firing furnace.

For example, the oxide-based solid electrolyte may be a solid electrolyte containing a Li element, a Y element (Y is at least one of Nb, B, Al, Si, P, Ti, Zr, Mo, W and S) and an O element. As the oxide-based solid electrolyte, examples include, but are not limited to, the following solid electrolytes: a garnet-type solid electrolyte such as Li₇La₃Zr₂O₁₂, Li₇₋ₓLa₃ (Zr₂₋ₓNbₓ) O₁₂ (0≤x≤2) and Li₅La₃Nb₂O₁₂; a perovskite-type solid electrolyte such as (Li, La) TiO₃, (Li, La) NbO₃ and (Li, Sr) (Ta, Zr) O₃; a nasicon-type solid electrolyte such as Li (Al, Ti) (PO₄) ₃ and Li (Al, Ga) (PO₄) ₃; a LiP-O-based solid electrolyte such as Li₃PO₄ and LIPON (a compound obtained by substituting at least one “O” of Li₃PO₄ with N); and a Li-B-O-based solid electrolyte such as Li₃BO₃ and a compound obtained by substituting at least one “O” of Li₃BO₃ with C. In the present disclosure, the notation “(A, B)” in the chemical formulae means “at least one of A and B”.

For example, the hydride-based solid electrolyte contains Li and a complex anion containing hydrogen. As the complex anion, examples include, but are not limited to, (BH₄) ⁻, (NH₂) ⁻, (AlH₄) ⁻ and (AlH₆) ³⁻.

As the halide-based solid electrolyte, examples include, but are not limited to, Li_{6-3z}Y_{z}X₆ (where X is at least one of Cl and Br, and z satisfies 0<z<2).

As the nitride-based solid electrolyte, examples include, but are not limited to, Li₃N.

The form of the solid electrolyte may be a particulate form, from the viewpoint of good handleability.

The average particle diameter of the solid electrolyte particles is not particularly limited. For example, the average particle diameter of the solid electrolyte particles may be 10 nm or more, or it may be 100 nm or more. On the other hand, the average particle diameter of the solid electrolyte particles may be 25 µm or less, or it may be 10 µm or less, for example. The average particle diameter of the solid electrolyte particles may be smaller than the thickness of the support, and it may be smaller than the diameter of the pores of the support.

In the present disclosure, the average particle diameter of the particles is the value of a volume-based median diameter (D50) measured by laser diffraction and scattering particle size distribution measurement, unless otherwise noted. In the present disclosure, the median diameter (D50) is a diameter (volume average diameter) such that the cumulative volume of the particles is half (50%) of the total volume when the particles are arranged in order of particle diameter from smallest to largest.

The solid electrolyte may be one kind of solid electrolyte, or it may be two or more kinds of solid electrolytes. In the case of using two or more kinds of solid electrolytes, they may be mixed together, or they may be formed into layers to obtain a multilayer structure.

The amount of the solid electrolyte in the solid electrolyte layer is not particularly limited. For example, it may be 50 mass % or more; it may be within a range of 60 mass % or more and 100 mass % or less; it may be within a range of 70 mass % or more and 100 mass % or less; or it may be 100 mass %.

A binder may also be contained in the solid electrolyte layer, from the viewpoint of expressing plasticity, etc. As the binder, examples include, but are not limited to, materials exemplified below as the binder used in the cathode layer. However, to facilitate high output, the binder contained in the solid electrolyte layer may be 5 mass % or less, from the viewpoint of preventing excessive aggregation of the solid electrolyte and enabling the formation of the solid electrolyte layer in which the solid electrolyte is uniformly dispersed.

### Cathode

The cathode includes a cathode layer. As needed, it includes a cathode collector.

### Cathode Layer

The cathode layer contains a cathode active material. As optional components, the cathode layer may contain a solid electrolyte, an electroconductive material, a binder, etc.

There is no particular limitation on the type of the cathode active material, and any material which can be used as an active material of a solid-state battery can be employed. As the cathode active material, examples include, but are not limited to, lithium metal (Li), a lithium alloy, LiCoO₂, LiNi_{0.}₈Co₀.₁₅Al_{0.}₀₅O₂, LiNiₓCo₁₋ₓO₂ (0<x<1), LiNi_{⅓}Co_{⅓}Mn_{⅓}O₂, LiMnO₂, a different element-substituted Li-Mn spinel, lithium titanate, lithium metal phosphate, LiCoN, Li₂SiO₃, and Li₄SiO₄, a transition metal oxide, TiS₂, Si, SiO₂, a Si alloy and a lithium storage intermetallic compound. As the different element-substituted Li-Mn spinel, examples include, but are not limited to, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. As the lithium titanate, examples include, but are not limited to, Li₄Ti₅O₁₂. As the lithium metal phosphate, examples include, but are not limited to, LiFePO₄, LiMnPO₄, LiCoPO₄ and LiNiPO₄. As the transition metal oxide, examples include, but are not limited to, V₂O₅ and MoO₃. As the lithium storage intermetallic compound, examples include, but are not limited to, Mg₂Sn, Mg₂Ge, Mg₂Sb and Cu₃Sb.

As the lithium alloy, examples include, but are not limited to, Li-Au, Li-Mg, Li-Sn, Li-Si, Li-Al, Li-B, Li-C, Li-Ca, Li-Ga, Li-Ge, Li-As, Li-Se, Li-Ru, Li-Rh, Li-Pd, Li-Ag, Li-Cd, Li-In, Li-Sb, Li-Ir, Li-Pt, Li-Hg, Li-Pb, Li-Bi, Li-Zn, Li-Tl, Li-Te and Li-At. As the Si alloy, examples include, but are not limited to, an alloy of Si and a metal such as Li, and an alloy of Si and at least one kind of metal selected from the group consisting of Sn, Ge and Al.

The form of the cathode active material is not particularly limited. It may be a particulate form. When the cathode active material is in a particulate form, the cathode active material may be primary particles or secondary particles.

On the surface of the cathode active material, a coating layer containing a Li ion conductive oxide may be formed. This is because a reaction between the cathode active material and the solid electrolyte can be suppressed.

As the Li ion conductive oxide, examples include, but are not limited to, LiNbO₃, Li₄Ti₅O₁₂, and Li₃PO₄. The thickness of the coating layer is, for example, 0.1 nm or more, and it may be 1 nm or more. On the other hand, the thickness of the coating layer is, for example, 100 nm or less, and it may be 20 nm or less. The coating rate of the coating layer on the surface of the cathode active material is, for example, 70% or more, and it may be 90% or more.

As the solid electrolyte, examples include, but are not limited to, those exemplified below in [Solid electrolyte layer] .

The amount of the solid electrolyte contained in the cathode layer is not particularly limited. It may be within a range of, for example, from 1 mass % to 80 mass % of the total mass (100 mass %) of the cathode layer.

As the electroconductive material, a known material can be used, such as a carbon material and metal particles. As the carbon material, examples include, but are not limited to, at least one selected from the group consisting of acetylene black, furnace black, VGCF, carbon nanotube and carbon nanofiber. Among them, at least one selected from the group consisting of VGCF, carbon nanotube and carbon nanofiber may be used, from the viewpoint of electron conductivity. As the metal particles, examples include, but are not limited to, particles of Ni, Cu, Fe and SUS.

The amount of the electroconductive material contained in the cathode layer is not particularly limited.

As the binder, examples include, but are not limited to, acrylonitrile butadiene rubber (ABR), butadiene rubber (BR), polyvinylidene fluoride (PVdF) and styrene butadiene rubber (SBR). The amount of the binder contained in the cathode layer is not particularly limited.

The thickness of the cathode layer is not particularly limited.

The cathode layer can be formed by a conventionally known method.

For example, the cathode active material and, as needed, other components are put in a solvent; they are stirred to prepare a slurry for a cathode layer; and the slurry for the cathode layer is applied on one surface of a substrate such as a cathode collector; and the applied slurry is dried, thereby obtaining the cathode layer.

As the solvent, examples include, but are not limited to, butyl acetate, butyl butyrate, mesitylene, tetralin, heptane, and N-methyl-2-pyrrolidone (NMP).

The method for applying the slurry for the cathode layer on one surface of the substrate such as the cathode collector, is not particularly limited. As the method, examples include, but are not limited to, the doctor blades method, the metal mask printing method, the static coating method, the dip coating method, the spread coating method, the roll coating method, the gravure coating method, and the screen printing method.

As the substrate, for example, a metal foil such as Cu and Al can be used.

As another method for forming the cathode layer, the cathode layer may be formed by pressure molding a cathode mixture powder containing the cathode active material and, as needed, other components. In the case of pressure molding the cathode mixture powder, generally, a press pressure of about 1 MPa or more and 2000 MPa or less is applied.

The method for applying the pressure is not particularly limited. As the method, examples include, but are not limited to, a pressure applying method using a plate press machine, a roll press machine, or the like.

### Cathode Collector

As the cathode collector, a known metal that can be used as the collector of solid-state battery, can be used. As the metal, examples include, but are not limited to, a metal material containing one or more elements selected from the group consisting of Cu, Ni, Al, V, Au, Pt, Mg, Fe, Ti, Co, Cr, Zn, Ge and In. As the cathode collector, examples include, but are not limited to, SUS, aluminum, nickel, iron, titanium and carbon.

The form of the cathode collector is not particularly limited. As the form, examples include, but are not limited to, various kinds of forms such as a foil form and a mesh form. The thickness of the cathode collector varies depending on the shape. For example, it may be in a range of from 1 µm to 50 µm, or it may be in a range of from 5 µm to 20 µm.

### Anode

The anode includes an anode layer. As needed, it includes an anode collector.

The anode layer contains at least an anode active material. As needed, it contains a solid electrolyte, an electroconductive material, a binder, etc.

As the anode active material, examples include, but are not limited to, graphite, mesocarbon microbeads (MCMB), highly oriented pyrolytic graphite (HOPG), hard carbon, soft carbon, elemental lithium, a lithium alloy, elemental Si, a Si alloy and Li₄Ti₅O₁₂. As the lithium alloy and the Si alloy, those exemplified above as the cathode active material may be used.

The form of the anode active material is not particularly limited. As the form, examples include, but are not limited to, a particulate form and a plate form. When the anode active material is in a particulate form, the anode active material may be primary particles or secondary particles.

As the electroconductive material and binder used in the anode layer, those exemplified above as the electroconductive material and binder used in the cathode layer, may be used. As the solid electrolyte used in the anode layer, those exemplified above in [Solid electrolyte layer] may be used.

The thickness of the anode layer is not particularly limited. For example, it may be from 10 µm to 100 µm.

The amount of the anode active material contained in the anode layer is not particularly limited. It may be from 20 mass % to 90 mass %, for example.

### Anode Collector

The material for the anode collector may be a material that is not alloyed with Li, such as SUS, copper and nickel. As the form of the anode collector, examples include, but are not limited to, a foil form and a plate form. The plan-view shape of the anode collector is not particularly limited, and examples thereof include, but are not limited to, a circular shape, an ellipse shape, a rectangular shape and any arbitrary polygonal shape. The thickness of the anode collector varies depending on the shape. For example, it may be in a range of from 1 µm to 50 um, or it may be in a range of from 5 µm to 20 µm.

As needed, the solid-state battery includes an outer casing for housing a stack including the cathode collector, the cathode layer, the solid electrolyte layer, the anode layer and the anode collector in this order, a fixing member, etc.

The material for the outer casing is not particularly limited, as long as it is a material stable in electrolyte. As the material, examples include, but are not limited to, a resin such as polypropylene, polyethylene and acrylic resin.

The fixing member is not particularly limited, as long as it can apply fixing pressure to the stack in the stacking direction. As the fixing member, a known fixing member that is applicable as the fixing member of solid-state batteries, may be used. For example, a fixing member including two plates sandwiching both surface of the stack, a rod connecting the plates, a controller being connected to the rod and controlling the fixing pressure by a screw structure or the like, may be used. By the controller, the desired fixing pressure can be applied to the stack.

The fixing pressure is not particularly limited. For example, it may be 0.1 MPa or more, may be 1 MPa or more, or may be 5 MPa or more. This is because it is advantageous in that the contact between the layers is easily enhanced by increasing the fixing pressure. On the other hand, the fixing pressure may be 100 MPa or less, may be 50 MPa or less, or may be 20 MPa or less, for example. This is because, when the fixing pressure is too large, there is a possibility that high stiffness is required of the fixing member, and the size of the fixing member is increased.

The solid-state battery may be composed of the single stack, or the solid-state battery may be composed of a stack of the stacks.

The solid-state battery may be a primary battery, or it may be a secondary battery. Among them, the solid-state battery may be a secondary battery. A secondary battery is a battery which can be repeatedly charged and discharged, and it is useful as an in-vehicle battery, for example. The solid-state battery may be a solid-state lithium secondary battery or a solid-state lithium ion secondary battery.

As the form of the solid-state battery, examples include, but are not limited to, a coin form, a laminate form, a cylindrical form and a square form.

In the present disclosure, the solid-state battery may be a solid-state battery which uses, instead of a liquid electrolyte containing an organic solvent, a solid electrolyte as the electrolyte of the electrolyte layer disposed between the cathode and the anode. The solid-state battery may be an all-solid-state battery in which the cathode, anode and electrolyte layer are all composed of solid materials.

As the applications of the solid-state battery, examples include, but are not limited to, the power sources of vehicles such as a hybrid electric vehicle (HEV), a plug-in hybrid electric vehicle (PHEV), a battery electric vehicle (BEV), a gasoline vehicle and a diesel vehicle. Especially, the solid-state battery of the present disclosure may be used in the driving power supply of a hybrid electric vehicle, a plug-in hybrid electric vehicle or a battery electric vehicle. Also, the solid-state battery of the present disclosure may be used as the powder source of mobile objects other than vehicles, such as railroads, ships and aircrafts, or it may be used as the power source of electrical appliances such as an information processing device.

The solid-state battery of the present disclosure may be produced by the following method, for example. First, the solid electrolyte layer composed of the three solid electrolyte layers (the first, second and third solid electrolyte layers) is prepared. Next, the cathode layer is obtained by pressure molding the cathode material powder containing the cathode active material on one surface of the solid electrolyte layer. Then, the anode layer is obtained by pressure molding the anode material powder on one surface of the anode collector. On a surface of the solid electrolyte layer, which is opposite to the surface on which the cathode layer is formed, an assembly of the anode collector and the anode layer is attached so that the anode layer is in contact with the solid electrolyte layer. Then, the cathode collector is attached on a surface of the cathode layer, which is opposite to the solid electrolyte layer. Accordingly, the solid-state battery of the present disclosure is obtained.

### EXAMPLES

### Example 1

### Production of a Cathode

As a cathode active material, a LiNi_{⅓}Mn_{⅓}Co_{⅓}O₂ powder having an average particle diameter (D50) of 5 µm, which is the diameter measured by the laser diffraction/scattering method, was used. The surface of the cathode active material was coated with LiNbO₃ by the sol-gel method.

As a sulfide-based solid electrolyte, a 15LiBr • 10LiI • 75 (0.75Li₂S • 0.25P₂S₅) glass ceramic having an average particle diameter (D50) of 2.5 µm, which is the diameter measured by the laser diffraction/scattering method, was used.

The cathode active material and the sulfide-based solid electrolyte were weighed in a ratio of 75:25. In addition, with respect to 100 parts by weight of the cathode active material, 3 wt. % of an SBR (styrene-butadiene rubber)-based binder and 10 wt. % of an electroconductive material (CNF) were weighed out, and they were mixed with butyl butyrate to obtain a solid content of 60 wt. %. The mixture was subjected to ultrasonic dispersion for one minute by use of an ultrasonic disperser, thereby obtaining a composition for cathode layer formation (a cathode layer paste).

Next, by blade coating with a commercially-available applicator, the cathode layer paste was evenly applied onto a cathode collector made of an aluminum foil having a thickness of 15 µm so that the coating weight was 15 mg/cm².

Next, a coating film thus obtained was dried at 100° C. for 60 minutes, thereby obtaining a cathode in which a cathode layer was formed on the cathode collector made of the aluminum foil.

### Production of an Anode

As an anode active material, a Si powder having an average particle diameter (D50) of 5 µm, which is the diameter measured by the laser diffraction/scattering method, was used.

As a solid electrolyte, the same sulfide-based solid electrolyte as the cathode was used.

The anode active material and the sulfide-based solid electrolyte were weighed in a ratio of 50:50. In addition, with respect to 100 parts by weight of the anode active material, 3 wt. % of an SBR-based binder and 10 wt. % of an electroconductive material (CNF) were weighed out, and they were mixed with butyl butyrate to obtain a solid content of 40 wt. %. The mixture was subjected to ultrasonic dispersion for one minute by use of an ultrasonic disperser, thereby obtaining a composition for anode layer formation (an anode layer paste).

Next, by blade coating with a commercially-available applicator, the anode layer paste was evenly applied onto an anode collector made of a surface-roughened copper foil having a thickness of 25 µm so that the coating weight was 3 mg/cm².

Next, a coating film thus obtained was dried at 100° C. for 60 minutes, thereby obtaining an anode in which an anode layer for batteries was formed on the anode collector made of the surface-roughened copper foil.

### Production of Solid Electrolyte Layers Not Including a Support

Solid electrolyte layers not including a support were produced by use of the sulfide-based solid electrolyte used for the production of the cathode. More specifically, 99 wt. % of the sulfide-based solid electrolyte and 1 wt. % of the SBR-based binder were weighed out, and they were mixed with butyl butyrate to obtain a solid content of 50 wt. %. The mixture was subjected to ultrasonic dispersion for one minute by use of the same ultrasonic disperser as the cathode, thereby obtaining a composition for solid electrolyte layer formation (a solid electrolyte layer paste).

Next, by the same operation as the above-described cathode production, the solid electrolyte layer paste was evenly applied onto an aluminum foil having a thickness of 15 µm so that the coating weight was 0.6 mg/cm² (thickness 3 µm) . Next, a coating film thus obtained was dried at 100° C. for 60 minutes, thereby producing a solid electrolyte layer not including a support on the aluminum foil. By the same method, a total of two solid electrolyte layers not including a support (the first and third solid electrolyte layers) were produced.

### Production of a Solid Electrolyte Layer Including a Support

A solid electrolyte layer including a support was produced by use of the sulfide-based solid electrolyte used for the production of the cathode. More specifically, 99 wt. % of the sulfide-based solid electrolyte and 1 wt. % of the SBR-based binder were weighed out, and they were mixed with butyl butyrate to obtain a solid content of 50 wt. %. The mixture was subjected to ultrasonic dispersion for one minute by use of the same ultrasonic disperser as the cathode, thereby obtaining a composition for solid electrolyte layer formation (a solid electrolyte layer paste).

Next, a non-woven fabric made of PET was stacked on an aluminum foil having a thickness of 15 µm. The non-woven fabric had a thickness of 25 µm and a porosity of 80%. By the same operation as the above-described cathode production, the solid electrolyte layer paste was evenly applied onto the aluminum foil so that the coating weight of the solid electrolyte was 4.8 mg/cm² (the thickness of the solid electrolyte layer including the non-woven fabric: 25 um)

Next, a coating film thus obtained was dried at 100° C. for 60 minutes, thereby producing a solid electrolyte layer including a support on the aluminum foil (the second solid electrolyte layer).

### Production of a Solid-State Battery (a Battery Assembly)

The first solid electrolyte layer (a solid electrolyte layer not including a support) was cut in the form of a 1.4 cm × 1.4 cm square in combination with the aluminum foil. In the same manner, the anode was cut in the form of a 1.4 cm × 1.4 cm square. The anode was stacked on the first solid electrolyte layer (a solid electrolyte layer not including a support) so that the anode layer was in contact with the first solid electrolyte layer (a solid electrolyte layer not including a support). They were pressed at a press pressure of 1 ton/cm², thereby obtaining a stack of the anode, the first solid electrolyte layer and the aluminum foil (hereinafter, it may be referred to as an “anode-first solid electrolyte layer-aluminum foil stack”).

Next, the aluminum foil of the anode-first solid electrolyte layer-aluminum foil stack was stripped from the first solid electrolyte layer. The second solid electrolyte layer (a solid electrolyte layer including a support) was cut in the same form as the first and third solid electrolyte layers. The second solid electrolyte layer was stacked on the first solid electrolyte layer (a solid electrolyte layer not including a support), and they were pressed at a press pressure of 1 ton/cm², thereby obtaining a stack of the anode, the first solid electrolyte layer and the second solid electrolyte layer (an anode-first solid electrolyte layer-second solid electrolyte layer stack).

Next, the third solid electrolyte layer (another solid electrolyte layer not including a support) was cut in the form of a 1 cm × 1 cm square in combination with the aluminum foil. In the same manner, the cathode was cut in the form of a 1.4 cm × 1.4 cm square. The cathode was stacked on the third solid electrolyte layer (a solid electrolyte layer not including a support) so that the cathode layer was in contact with the third solid electrolyte layer (a solid electrolyte layer not including a support), and they were pressed at a press pressure of 1 ton/cm², thereby obtaining a stack of the cathode, the third solid electrolyte layer and the aluminum foil (a cathode-third solid electrolyte layer-aluminum foil stack).

Next, the second solid electrolyte layer (a solid electrolyte layer including a support) stacked on the anode and the third solid electrolyte layer (a solid electrolyte layer not including a support) stacked on the cathode were stacked. They were pressed at a press pressure of 3 tons/cm², thereby obtaining a stack of the anode, the first solid electrolyte layer, the second solid electrolyte layer, the third solid electrolyte layer and the cathode (an anode-first solid electrolyte layer-second solid electrolyte layer-third solid electrolyte layer-cathode stack.

The thus-obtained stack was enclosed in an outer casing, thereby producing the test solid-state battery of Example 1. The outer casing was made of an aluminum laminate film and equipped with cathode and anode terminals, and the test solid-state battery was a solid-state lithium ion secondary battery.

### Example 2

By use of the same materials and processes as Example 1, the test solid-state battery of Example 2 (a solid-state lithium ion secondary battery) was produced, except for the following: in the solid electrolyte layer production, the coating weight of the solid electrolyte of the first and third solid electrolyte layers (solid electrolyte layers not including a support) was changed to 1.0 mg/cm² (thickness 5 µm); the thickness of the non-woven fabric of the second solid electrolyte layer (a solid electrolyte layer including a support) was changed to 20 µm; and the coating weight of the solid electrolyte of the second solid electrolyte layer was changed to 3.9 g/cm² (the thickness of the solid electrolyte layer including the non-woven fabric: 20 µm) .

### Example 3

By use of the same materials and processes as Example 1, the test solid-state battery of Example 3 (a solid-state lithium ion secondary battery) was produced, except for the following: in the solid electrolyte layer production, the coating weight of the solid electrolyte of the first and third solid electrolyte layers (solid electrolyte layers not including a support) was changed to 2.0 mg/cm² (thickness 10 µm); the thickness of the non-woven fabric of the second solid electrolyte layer (a solid electrolyte layer including a support) was changed to 10 µm; and the coating weight of the solid electrolyte of the second solid electrolyte layer was changed to 1.9 mg/cm² (the thickness of the solid electrolyte layer including the non-woven fabric: 10 µm) .

### Example 4

By use of the same materials and processes as Example 1, the test solid-state battery of Example 4 (a solid-state lithium ion secondary battery) was produced, except for the following: the thickness of the first and third solid electrolyte layers (solid electrolyte layers not including a support) was changed to 10 µm; the thickness of the second solid electrolyte layer (a solid electrolyte layer including a support) was changed to 20 um; and in the solid-state battery production, the first solid electrolyte layer (a solid electrolyte layer not including a support) was not stacked on the anode, thereby obtaining a stack of the anode, the second solid electrolyte layer, the third solid electrolyte layer and the cathode (an anode-second solid electrolyte layer-third solid electrolyte layer-cathode stack).

### Example 5

By use of the same materials and processes as Example 1, the test solid-state battery of Example 5 (a solid-state lithium ion secondary battery) was produced, except for the following: the thickness of the first and third solid electrolyte layers (solid electrolyte layers not including a support) was changed to 10 µm; the thickness of the second solid electrolyte layer (a solid electrolyte layer including a support) was changed to 20 um; and in the solid-state battery production, the third solid electrolyte layer (a solid electrolyte layer not including a support) was not stacked on the cathode, thereby obtaining a stack of the anode, the first solid electrolyte layer, the second solid electrolyte layer and the cathode (an anode-first solid electrolyte layer-second solid electrolyte layer-cathode stack).

### Comparative Example 1

By use of the same materials and processes as Example 1, the test solid-state battery of Comparative Example 1 (a solid-state lithium ion secondary battery) was produced, except for the following: in the solid electrolyte layer production, the coating weight of the solid electrolyte of the first solid electrolyte layer (a solid electrolyte layer not including a support) was changed to 6.0 mg/cm² (thickness 30 µm), and in the solid-state battery production, only the first solid electrolyte layer (a solid electrolyte layer not including a support) was stacked on the anode, and the third solid electrolyte layer (a solid electrolyte layer not including a support) was not stacked on the cathode, thereby obtaining a stack of the anode, the first solid electrolyte layer and the cathode (an anode-first solid electrolyte layer-cathode stack).

By use of the same materials and processes as Example 1, the test solid-state battery of Comparative Example 2 (a solid-state lithium ion secondary battery) was produced, except for the following: in the solid electrolyte layer production, the coating weight of the solid electrolyte of the second solid electrolyte layer (a solid electrolyte layer including a support) was changed to 5.8 mg/cm² (the thickness of the solid electrolyte layer including the non-woven fabric: 30 µm), and in the solid-state battery production, only the second solid electrolyte layer (a solid electrolyte layer including a support) was stacked on the anode, and the third solid electrolyte layer (a solid electrolyte layer not including a support) was not stacked on the cathode, thereby obtaining a stack of the anode, the second solid electrolyte layer and the cathode (an anode-second solid electrolyte layer-cathode stack).

### Evaluation

### Test 1: Battery Resistance Measurement

Each of the solid-state batteries of Examples 1 to 5 and Comparative Examples 1 and 2 was fixed at 100 MPa and charged and discharged as follows. Each battery was charged with constant current at a current rate of 1 mA until the voltage reached 4.5 V; the battery was charged with constant voltage until the current reached 0.01 mA; the battery was discharged with constant current at a current rate of 1 mA until the voltage reached 4.0 V; and then the battery was discharged with constant voltage until the current reached 0.01 mA. Then, the battery was left to stand for one hour.

Next, the battery was discharged with constant current at a current rate 10 mA for 10 seconds. Then, the battery resistance was measured according to the law of Ohm. The battery resistances of Examples 1 to 5 and Comparative Examples 1 and 2 are shown in Table 1.

### Test 2: Cycle Test

After the measurement 1 was completed, charge and discharge of each solid-state battery was repeated 100 cycles as follows. The battery was charged with constant current at a current rate of 1 mA until the voltage reached 4.5 V; the battery was charged with constant voltage until the current reached 0.01 mA; the battery was discharged with constant current at a current rate of 1 mA until the voltage reached 3.0 V; and then the battery was discharged with constant voltage until the current reached 0.01 mA. The ratio of the discharge capacity of the 100th cycle to the discharge capacity of the first cycle, was defined as the capacity retention rate of each solid-state battery, and the capacity retention rates of the solid-state batteries of Examples 1 to 5 and Comparative Examples 1 and 2 were compared to each other. The capacity retention rates are shown in Table 1.

Capacity retention rate (%):

(Discharge capacity of the 100th cycle / Discharge capacity of the first cycle) × 100

TABLE 1

| | Thickness (µm) of the first solid electrolyte layer | Thickness (µm) of the second solid electrolyte layer | Thickness (µm) of the third solid electrolyte layer | Battery resistance (Ω) | Capacity retention rate (%) |
|---|---|---|---|---|---|
| Example 1 | 3 | 25 | 3 | 81.0 | 54.9 |
| Example 2 | 5 | 20 | 5 | 80.5 | 54.4 |
| Example 3 | 10 | 10 | 10 | 81.2 | 53.9 |
| Example 4 | - | 20 | 10 | 83.6 | 54.1 |
| Example 5 | 10 | 20 | - | 83.9 | 54.3 |
| Comparative Example 1 | 30 | - | - | 80.8 | 49.3 |
| Comparative Example 2 | - | 30 | - | 92.2 | 54.4 |

### Results

While the solid-state batteries of Examples 1 to 3 maintained a capacity retention rate increasing effect, which is due to the support introduced therein, their battery resistances are equivalent to those of the solid-state batteries in which a support was not introduced. This indicates that while contact resistance between an electrode and a solid electrolyte layer including a support is high, an increase in resistance is suppressed by interposing a solid electrolyte layer not including a support between an electrode and a solid electrolyte layer including a support.

It was confirmed that the battery resistances of the solid-state batteries of Examples 4 and 5, each of which used the solid electrolyte layer having a two-layer structure composed of a solid electrolyte layer not including a support and a solid electrolyte layer including a support, were lower than the battery resistance of the solid-state battery of Comparative Example 2, which used the solid electrolyte layer having a single layer structure composed of a solid electrolyte layer including a support.

### REFERENCE SIGNS LIST

11. Anode collector
12. Anode layer
13. First solid electrolyte layer
14. Second solid electrolyte layer
15. Third solid electrolyte layer
16. Cathode layer
17. Cathode collector
100. Solid-state battery

1. A solid-state battery comprising a cathode layer, a solid electrolyte layer and an anode layer in this order,
wherein the solid electrolyte layer comprises a first solid electrolyte layer and a second solid electrolyte layer;
wherein the first solid electrolyte layer is disposed adjacent to the cathode layer or the anode layer;
wherein the second solid electrolyte layer is disposed adjacent to the first solid electrolyte layer;
wherein the first solid electrolyte layer comprises a solid electrolyte; and
wherein the second solid electrolyte layer comprises a support with pores and the solid electrolyte, and the second solid electrolyte layer is a sheet in which the solid electrolyte is fixed on a surface of and in the pores of the support.

2. The solid-state battery according to claim 1,
wherein the solid electrolyte layer further comprises a third solid electrolyte layer;
wherein the first solid electrolyte layer is disposed adjacent to the anode layer;
wherein the third solid electrolyte layer is disposed adjacent to the cathode layer;
wherein the second solid electrolyte layer is disposed between the first solid electrolyte layer and the third solid electrolyte layer; and
wherein the third solid electrolyte layer comprises the solid electrolyte.

3. The solid-state battery according to claim 1, wherein a porosity of the support is 70% or more and 90% or less.

4. The solid-state battery according to claim 1, wherein the support is a non-woven fabric.

5. The solid-state battery according to claim 1, wherein the solid electrolyte is a sulfide-based solid electrolyte.

6. The solid-state battery according to claim 1, wherein a thickness of the second solid electrolyte layer is 10 µm or more and 25 µm or less.

7. The solid-state battery according to claim 2, wherein a thickness of the first solid electrolyte layer and that of the third solid electrolyte layer are 3 µm or more and 10 µm or less.
